(19) United States
(12) Patent Application Publication
(10) Pub. No.: US 2009/0042534 A1
(43) Pub. Date: Feb. 12, 2009

(54) Personal security tracking system and method

(76) Inventor: Janne Levanen, Alta Loma, CA (US)

Correspondence Address: LAW OFFICES OF ERIC KARICH, 2807 ST. MARK DR., MANSFIELD, TX, 76063, US

(21) Appl. No.: 11/890,852

(22) Filed: Aug. 8, 2007

(51) Int. Cl. H04M 11/04

(52) U.S. Cl. 455/404.2; 340/573.4

(57) ABSTRACT

A personal security tracking system and method for alerting a public safety answering point that a child is endangered, and reporting the location of the child using a GPS system, has a portable signaling unit adapted to be worn by the child. The portable signaling unit comprises a microcontroller operably connected with a recorded message memory for playing a message informing the public safety answering point that the child is endangered. The microcontroller is also operably connected to a GPS receiver for determining the location of the child using the GPS system. A cell transmitter calls 911 and transmits the recorded message and the location of the child upon the initiation of a control button.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to personal security tracking systems, and more particularly to a personal security tracking system and method for alerting a public safety answering point to a child becoming endangered, and directing emergency responders to the endangered child.

2. Description of Related Art

A variety of child locating and personal security devices, bracelets, watches, and the like, are known in the art. The majority of the devices function to contact and alert a central dispatch center so that the employees of the central dispatch center can assist the user, or can call for emergency services on behalf of the user. Examples of this type of system are shown in Hoffman, U.S. Pat. No. 7,038,590, Underwood, U.S. Pat. No. 6,278,370, and Elliot, U.S. Pat. No. 6,243,039.

While contacting a central dispatch center makes the system simpler to arrange and control, it is also more expensive to operate; and furthermore, routing calls to the central dispatch center delays assistance to the user, and can result in critical mistakes, if the incoming calls are not handled correctly. The high cost of operating a central dispatch center around the clock, and the high cost of insuring such a system, has prohibited the commercial adoption of these systems to date.

Other systems, such as Lawrence, U.S. Pat. No. 5,021,794, rely on coded UHF homing signals to locate the child. Such a system is not only less accurate than modern GPS systems, it also requires the development of necessary infrastructure, and training of thousands of police to execute the system. This system has also failed to be adopted commercially.

The child locator illustrated in Elliot, U.S. Pat. No. 6,243,039, also teaches tracking a child via GPS on a computer, via the Internet. While such a system has convenient advantages to parents tracking the daily movements of their children, it is not efficient in directing immediate police rescue efforts towards a child that has been kidnapped. The above-described references are hereby incorporated by reference in full.

The prior art teaches various child tracking devices for tracking the location of a child. However, the prior art does not teach a personal security tracking system that directly calls 911 to alert an existing public safety answering point as to the child being endangered or having been kidnapped. The present invention fulfills these needs and provides further related advantages as described in the following summary.

### SUMMARY OF THE INVENTION

The present invention teaches certain benefits in construction and use which give rise to the objectives described below.

The present invention provides a personal security tracking system for alerting a public safety answering point that a child is endangered, and reporting the location of the child using a GPS system. The personal security tracking system includes a portable signaling unit adapted to be worn by the child. The portable signaling unit comprises a microcontroller; a recorded message memory for playing a message informing the public safety answering point that the child is endangered; a GPS receiver operably connected with the microcontroller for determining the location of the child using the GPS system; a cell transmitter; a cell programming memory for storing a programmed cell phone number, and programming for automatically calling 911; and a control button for initiating the cell transmitter for calling 911, transmitting the cell phone number stored in the cell programming memory, and playing the message recorded on the recorded message memory.

A primary objective of the present invention is to provide a personal security tracking system having advantages not taught by the prior art.

Another objective is to provide a personal security tracking system that directly calls 911 to alert an existing public safety answering point as to the child being endangered or having been kidnapped.

Another objective is to provide a method of automatically calling 911 and playing a recorded message requesting assistance be sent to the location of the child, and also transmitting the GPS coordinates of the child so that the assistance is guided directly to the child.

A further objective is to provide a personal security tracking system that does not require a dedicated infrastructure to receive emergency calls and immediately direct medical and/or police aide where required.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 illustrates a personal security tracking system according to a preferred embodiment of the present invention, the personal security tracking system including a portable signaling unit for tracking the location of a child that is endangered, and reporting the location to a public safety answering point;

FIG. 2 is a top plan view of one embodiment of the portable signaling unit;

FIG. 3 is a block diagram of the portable signaling unit;

FIG. 4 is a table illustrating one embodiment of a user database; and

FIG. 5 is a table illustrating one embodiment of a child database included within the user database.

### DETAILED DESCRIPTION OF THE INVENTION

The above-described drawing figures illustrate the invention, a personal security tracking system 10 that includes a portable signaling unit 30 adapted to be worn by a child 12. The a portable signaling unit 30 functions to call 911 and alert a public safety answering point 14 when the child 12 is endangered, and report the location of the child 12 so that he or she may be rescued. The personal security tracking system 10 is particularly useful when a child 12 has been abducted; however, it may also be used in the case of an injury or other emergency, or even if a third party has been harmed and the child 12 is unable to contact the public safety answering point 14 using ordinary means.

Furthermore, while a child 12 is discussed in particular, the term child 12 is hereby defined to also include other persons, as the system 10 is equally useful for adults, persons with physical disabilities, the elderly, young women, and anyone else that may require monitoring and tracking for their safety.

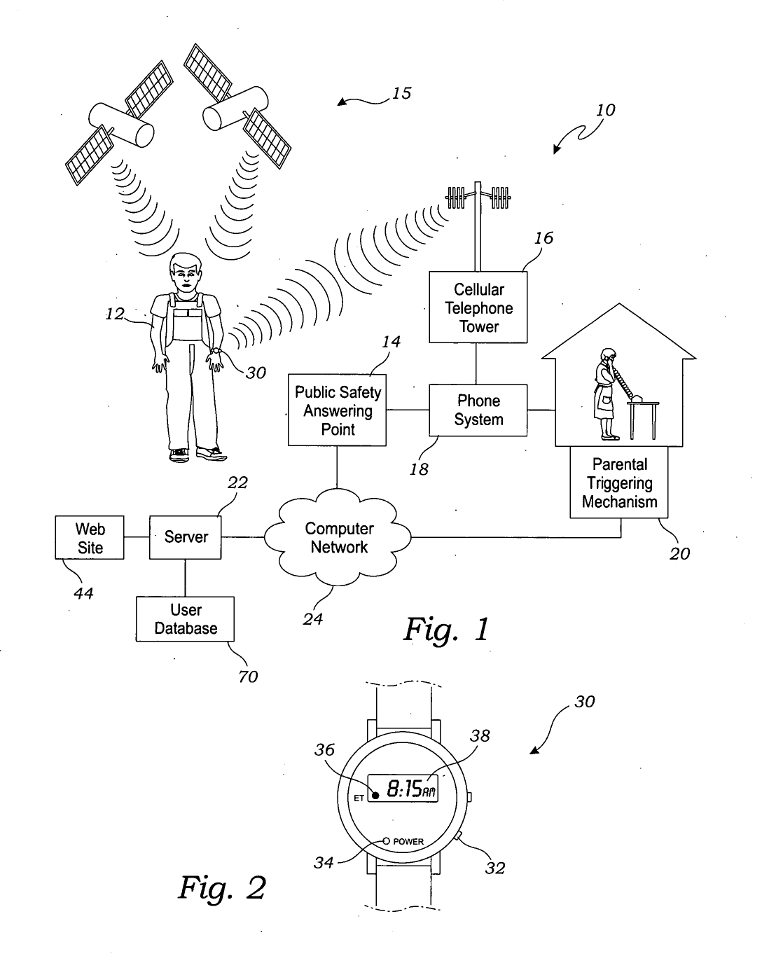

FIG. 1 illustrates the personal security tracking system 10 according to a preferred embodiment of the present invention. As illustrated in FIG. 1, the personal security tracking system 10 including the portable signaling unit 30 for tracking the location of a child 12 that is endangered using a GPS system 15, calling 911 via a cellular telephone tower 16 or towers, and reporting the location to the public safety answering point 14 via a phone system 18. In a preferred embodiment, a parental triggering mechanism 20 may also be used to initiate the call to 911 from the portable signaling unit 30, as discussed in greater detail below.

The personal security tracking system 10 preferably further includes a server 22 operably connected with a computer network 24 accessible by the public safety answering point 14. The server 22 has a user database 70 that includes information about the child 12 associated with the cell phone number 72. The user database 70 may be accessed by the public safety answering point 14, as discussed in greater detail below.

FIG. 2 is a top plan view of one embodiment of the portable signaling unit 30. In the embodiment of FIG. 2, the portable signaling unit 30 is in the form of a watch worn by the child 12. In other embodiments, the portable signaling unit 30 may in other forms, although the portable signaling unit 30 should be comfortable for the child 12 to wear, and inconspicuous so that it cannot be identified and removed by a kidnapper or other unauthorized person.

The portable signaling unit 30 includes a control button 32 for triggering the call to 911. The term “control button 32” is hereby defined to include any mechanism for triggering the portable signaling unit 30, including any form of button, switch, trigger, or code entered into the portable signaling unit 30. The control button 32 in the present embodiment is a simple button located inconspicuously on the side of the watch. The control button 32 is preferably shaped and otherwise adapted so that it will not likely be triggered accidentally, but is still easily activated in the event of an emergency. In some embodiments, the control button 32 may need to be depressed multiple times, in a certain pattern, or in conjunction with a second button, so that the call to 911 is not triggered accidentally.

The portable signaling unit 30 may also include a low battery sensor 35 operably connected with a low power LED 34 for warning when the portable signaling unit 30 needs to be recharged; and the portable signaling unit 30 may further include an electronic transmission notification 36 (ET) for notifying the user that the call to 911 has been made and that the message is being transmitted. The electronic transmission notification 36 should be inconspicuous, so that it is apparent to the user, but does not alert a kidnapper that a signal is being sent. A small and inconspicuous dot on an LCD screen 38 of the watch may be utilized for this purpose. Alternatively, a vibration device (not shown) could also be used. Those skilled in the art may devise many alternative signaling mechanisms, and these alternatives should be considered within the scope of the present invention.

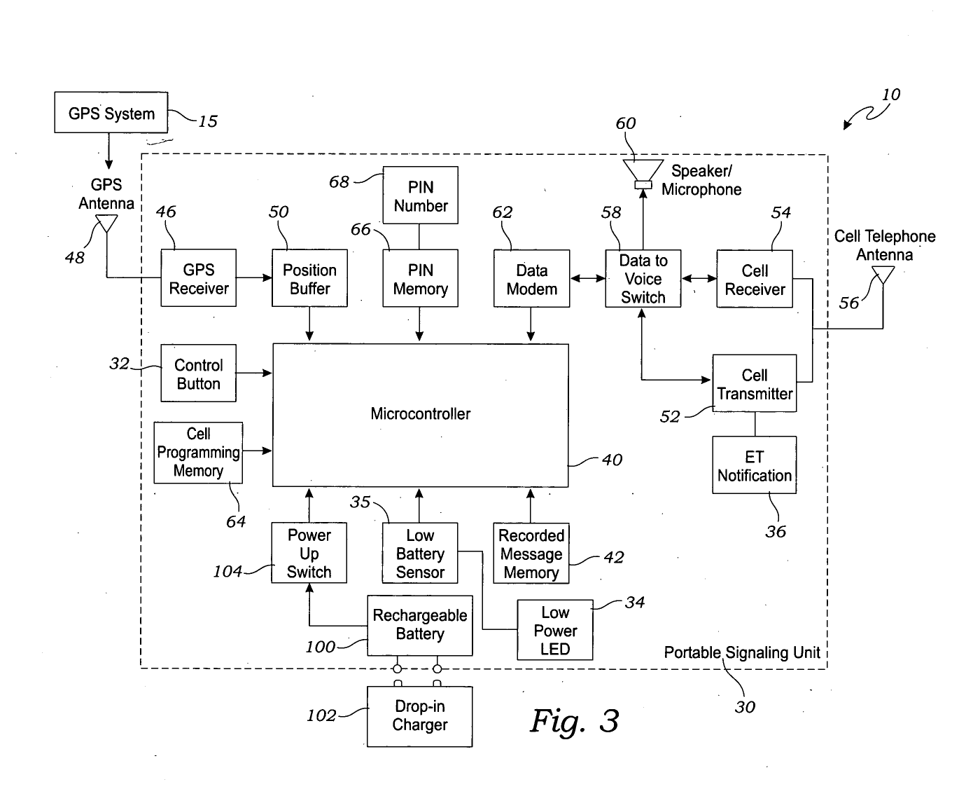

FIG. 3 is a block diagram of the portable signaling unit 30. As illustrated in FIG. 3, the portable signaling unit 30 includes a microcontroller 40 for controlling the operation of the portable signaling unit 30. The general construction of such a microcontroller 40 is well known to those skilled in the art, and is therefore not described in greater detail herein.

A recorded message memory 42 is operably connected with the microcontroller 40 for playing a message informing the public safety answering point 14 that the child 12 is endangered. The recorded message memory 42 may be provided by any suitable memory device, and preferably includes verbal instructions to the emergency response personnel working at the public safety answering point 14. The instructions preferably instruct the emergency response personnel to dispatch emergency services for both injury and potentially for an abduction. The instructions may also include direction to a web site 44 maintained on the server 22, so that the emergency response personnel can access information about the child 12 drawn from the user database 70 with reference to the cell phone number 72 of the portable signaling unit 30 (which will be displayed on the caller ID at the public safety answering point 14).

A GPS receiver 46 is also operably connected with the microcontroller 40 for determining the location of the child 12 using the GPS system 15. The GPS receiver 46 is preferably operably connected to a GPS antenna 48 for receiving signals from the GPS system 15 (a network of satellites), and to a position buffer 50 that receives the necessary information for determining the location of the portable signaling unit 30. The construction and function of the GPS receiver 46 and related hardware and software are well known in the art, and are therefore not described in greater detail herein.

While the portable signaling unit 30 in the preferred embodiment utilizes the GPS receiver 46 and the GPS system 15 of satellites, the term “GPS system 15” (and related terminology) is expressly defined to include alternative systems such as a cellular telephone Automatic Location Identification (ALI) system, as well as LORAN-C and GLONASS systems, and other alternative systems known in the art or developed in the future.

Also illustrated in FIG. 3, the portable signaling unit 30 further includes a cell transmitter 52 and a cell receiver 54 operably connected to a cell telephone antenna 56. The cell transmitter 52 may include the electronic transmission notification 36, described above, for signaling that the cell transmitter 52 is transmitting. The electronic transmission notification 36 may be displayed on the LCD screen 38 (as illustrated in FIG. 2, and as described above), or it may be provided by a small LED, or any other suitable signal. In other embodiments, however, the portable signaling unit 30 may not include sign a signal, so as to not alert a kidnapper to the operation of the portable signaling unit 30.

The cell receiver 54 may be operable connected with a data to voice switch 58, which may be operably connected to a speaker/microphone 60 (for embodiments when the portable signaling unit 30 may be used to directly communicate with the public safety answering point 14), and to a data modem 62 for exchanging data with the microcontroller 40.

A cell programming memory 64 is operably connected to the microcontroller 40 for receiving the cell phone number 72 (pre-programmed) and programming for calling 911. The control button 32, described above, is also operably connected to the portable signaling unit 30 for initiating the cell transmitter 52 for calling 911, transmitting the cell phone number 72, and playing the message recorded on the recorded message memory 42.

In the preferred embodiment of FIG. 3, the portable signaling unit 30 further includes a PIN memory 66 for receiving a PIN number 68. The PIN number 68 is preferably pre-assigned, and stored in the portable signaling unit 30, although it may be customized by the user using techniques that may be devised by those skilled in the art. In operation, the parental triggering mechanism 20 (shown in FIG. 1) may be used to call the cell receiver 54 and then input the PIN number 68 to activate the portable signaling unit 30. The parental triggering mechanism 20 may be an ordinary phone (wired or cellular), a computer operably connected to the computer network 24, a specialty and proprietary electronic device, or any other mechanism that can receive and transmit the PIN number 68.

The portable signaling unit 30 is preferably powered by a rechargeable battery 100 that is adapted to interface with a drop-in charger 102 for nightly or weekly charging of the portable signaling unit 30. A power up switch 104 may be included, so that the portable signaling unit 30 can be turned off while not in use; however, the portable signaling unit 30 may be adapted to always remain on.

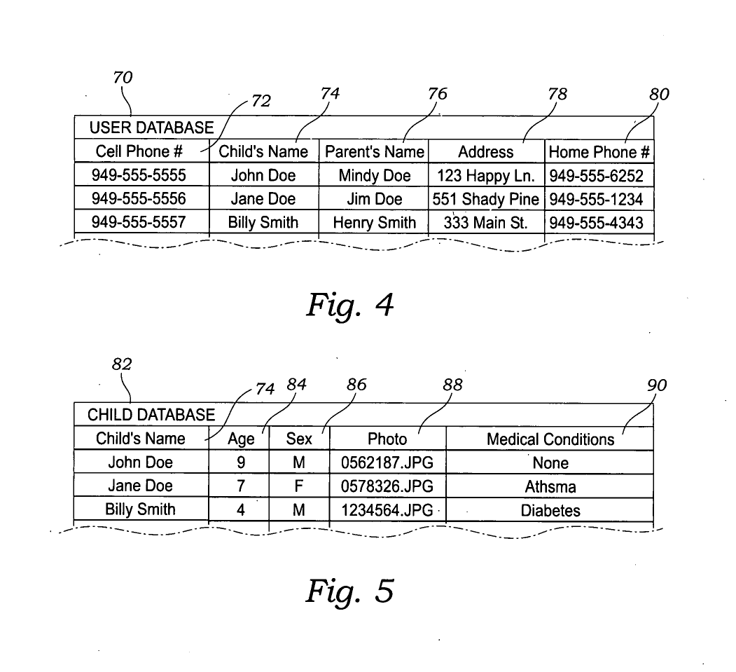

FIG. 4 is a table illustrating one embodiment of a user database 70. In the embodiment of FIG. 4, the user database 70 includes a cell phone number 72 (of the portable signaling unit 30), a child's name 74, a parent's name 76, address 78, and home phone number 80 (or multiple such contact persons). This information can be used for administrative purposes, and also for contacting the parents in the event of an emergency.

FIG. 5 is a table illustrating one embodiment of a child database 82 included within the user database 70. The child database 82 uses the child's name 74 (or, alternatively, the cell phone number 72 or other identifying information) from the user database 70 to link with other information about the child 12, such as an age 84 (or birthdate), a sex 86, a photo 88, and medical conditions 90. When the emergency response personnel are attempting to locate and assist the child 12, they can access the photo(s) 88 and other information to make the search faster and easier. All of this information is preferably accessible on the web site 44 of the server 22 via the computer network 24 so that the parents can keep the information up to date, upload more recent photographs, and otherwise maintain the system.

FIGS. 1-5 also help illustrate a method for alerting the public safety answering point 14 that the child 12 is endangered, and reporting the location of the child 12 using the GPS system 15, using the above-described portable signaling unit 30. The portable signaling unit 30 is attached to the child 12 in any manner known in the art. In the embodiment wherein the portable signaling unit 30 is a watch, it is simply attached to the wrist of the child 12. Other forms of jewelry, clothing, or other devices may also be used. In some embodiments, the portable signaling unit 30 is adapted to be locked onto the child 12 to resist removal or loss of the portable signaling unit 30.

If the child 12 is old enough and able to trigger the portable signaling unit 30, in the preferred embodiment the portable signaling unit 30 is directly triggered by the child 12 using the control button 32. If the child 12 is too young, or is restrained or otherwise unable to trigger the portable signaling unit 30, then the parents can trigger the portable signaling unit 30 using the parental triggering mechanism. The parent directly calls the cell phone number 72 and enters the PIN number 68 upon connection. The portable signaling unit 30 then functions to hang up the call with the parent, and immediately call 911 using the cell transmitter 52. The cell phone number 72 is transmitted from the cell transmitter 52 to the public safety answering point 14, and the message recorded on the recorded message memory 42 is played, alerting the emergency personnel working at the public safely answering point. The location of the child 12 as determined by the GPS receiver 46 is also reported periodically, so that the police and/or medical personnel can quickly converge on the location.

Occasionally, there are problems using cell phones of this nature, and it is not uncommon that calls do not go through, are prematurely dropped. The portable signaling unit 30 is preferably programmed to deal with these situations and automatically redial 911 if the call does not go through, or is dropped. Each time, the portable signaling unit 30 should replay the recorded message, so that emergency personnel can continue to track the child 12.

While converging on the location of the child 12 as reported, the police and/or medical personnel can access the server 22 via any computer and access photo graphs and personal data about the child 12 with reference to the cell phone number 72 transmitted by the portable signaling unit 30 (and easily accessible on the caller ID display of any phone).

The terminology used in the specification provided above is hereby defined to include similar and/or equivalent terms, and/or alternative embodiments that would be considered obvious to one skilled in the art given the teachings of the present patent application. Additionally, the words “a,” “an,” and “one” are defined to include one or more of the referenced item unless specifically stated otherwise. Also, the terms “have,” “include,” “contain,” and similar terms are defined to mean “comprising” unless specifically stated otherwise.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A personal security tracking system for alerting a public safety answering point that a child is endangered, and reporting the location of the child using a GPS system, the personal security tracking system comprising:
a portable signaling unit adapted to be worn by the child, the portable signaling unit comprising:
a microcontroller;
a recorded message memory for playing a message informing the public safety answering point that the child is endangered;
a GPS receiver operably connected with the microcontroller for determining the location of the child using the GPS system;
a cell transmitter;
a cell programming memory for storing a programmed cell phone number, and programming for automatically calling 911; and
a control button for initiating the cell transmitter for calling 911, transmitting the cell phone number stored in the cell programming memory, and playing the message recorded on the recorded message memory.

2. The personal security tracking system of claim 1, further comprising:
a server operably connected with a computer network accessible by the public safety answering point, the server having a user database that includes information about the child associated with the cell phone number.

3. The personal security tracking system of claim 1, wherein the portable signaling unit further includes a PIN memory for receiving a PIN number, and wherein receiving a call via a cell receiver and receiving the PIN number activates the portable signaling unit.

4. A method for alerting a public safety answering point that a child is endangered, and reporting a location of the child using a GPS system, the method comprising the steps of:
providing a portable signaling unit comprising:
a microcontroller;
a recorded message memory operably connected with the microcontroller for storing a message reporting that the child is endangered;
a GPS receiver operably connected with the microcontroller for determining the location of the child using the GPS system;
a cell transmitter; and
a cell programming memory having programming for calling 911;
attaching the portable signaling unit to the child;
calling 911 using the cell transmitter in response to the child being endangered;
playing the message recorded on the recorded message memory; and
reporting periodically the location of the child as determined by the GPS receiver.

5. The method of claim 4, wherein the cell programming memory further includes a cell phone number, and further comprising the step of transmitting the cell phone number from the cell transmitter to the public safety answering point.

6. The method of claim 4, wherein the step of calling the public safety answering point is initiated by a call from a parental triggering mechanism to the portable signaling unit, and the entry of a PIN number into the parental triggering mechanism matching the PIN number stored in the PIN memory of the portable signaling unit.

7. A method for alerting a public safety answering point that a child is endangered, and reporting a location of the child using a GPS system, the method comprising the steps of:
providing a portable signaling unit comprising:
a microcontroller;
a recorded message memory for playing a message that the child is endangered;
a GPS receiver operably connected with the microcontroller for determining the location of the child using the GPS system;
a cell transmitter; and
a cell programming memory for receiving a cell phone number and for receiving programming for placing cellular calls;
attaching the portable signaling unit to the child;
calling the portable signaling unit from a parental triggering mechanism;
entering a PIN number matching the PIN number stored in the PIN memory;
calling 911 using the cell transmitter of the portable signaling device in response to the receipt of the PIN number;
transmitting the cell phone number from the cell transmitter to the public safety answering point;
playing the message recorded on the recorded message memory; and
reporting periodically the location of the child as determined by the GPS receiver.
